(19) United States
(12) Patent Application Publication
(10) Pub. No.: US 2013/0157121 A1
(43) Pub. Date: Jun. 20, 2013

(54) ELECTROCHEMICAL CELL

(71) Applicant: Seiko Instruments Inc., Chiba-shi (JP)

(72) Inventors: Tsuneaki TAMACHI, Chiba-shi (JP); Ryo SATO, Chiba-shi (JP); Shunji WATANABE, Chiba-shi (JP); Maki OKUBO, Chiba-shi (JP)

(73) Assignee: SEIKO INSTRUMENTS INC., Chiba-shi (JP)

(21) Appl. No.: 13/657,282

(22) Filed: Oct. 22, 2012

(30) Foreign Application Priority Data
Dec. 19, 2011 (JP) 2011-277499

(51) Int. Cl. H01M 2/08

(52) U.S. Cl. 429/185

(57) ABSTRACT

A high-quality electrochemical cell is provided that can suppress lowering of charge-discharge efficiency, and that can stably maintain the charge-discharge cycle characteristics over extended time periods. The electrochemical cell includes: a sealing container that includes a base member, and a lid member welded to the base member via a weld layer, the base member and the lid member sealing and defining a storage space in between: and a chargeable and dischargeable electrochemical element housed in the storage space and that includes a positive electrode, a negative electrode, and a separation member impregnated with a nonaqueous electrolytic solution the positive electrode is electrically connected to the base member. The negative electrode is electrically connected to the lid member by being overlaid on the positive electrode via the separation member, and allows cations and/or anions to move between the positive electrode and the negative electrode through the nonaqueous electrolytic solution. The lid member is formed of a metallic material that contains nickel. The negative elect ode has a greater capacitance than the positive electrode,

### RELATED APPLICATIONS

This application claims priority under 35 U.S.C. §119 to Japanese Patent Application No. 2011-277499 filed on Dec. 19, 2011, the entire content of which is hereby incorporated by reference.

### BACKGROUND OF THE INVENTION

1. Field of the Invention

The present invention relates to electrochemical cells for devices such as nonaqueous electrolytic solution secondary batteries, and electric double-layer capacitors.

2. Description of the Related Art

Electrochemical cells have been used as the backup power supply for the memory and the clock function of various types of small electronic devices such as cell phones. PDAs, and portable gaining machines. One known example of electrochemical cells is a coin-shaped (button-shaped) electrochemical cell that is sealed by swaging a battery canister. A more recent variety is a substantially quadrangular (chip-shaped) electrochemical cell that can make effective use of the mount area (see, for example, JP-A-7001-216952).

Unlike the coin-shaped electrochemical cell, the chip-shaped electrochemical cell does not involve swaging (crimping) for the sealing of the canister (casing). Instead, the electrodes and other components are sealed in a sealing container formed by welding a depressed container to a sealing plate,

In the chip-shaped electrochemical cell, a nonaqueous electrolytic solution containing an organic solvent is housed in the sealing container, and is metallic sealing plate is welded via a metal ring to seal a ceramic depressed container. As the materials of the scaling plate and the metal ring, materials such as kovar (an alloy of Co: 17 weight %, Ni: 29 weight %, and Fe: the remaining part) are preferably used to match the thermal expansion with the ceramic depressed container.

In the chip-shaped electrochemical cell, it has been thought that the sealing plate and the metal ring are usually maintained at the reduced potential and do not dissolve. However, a problem occurs during the repeated cycles of charge and discharge over extended use of the electrochemical cell. Specifically, the charge-discharge efficiency lowers as a result of the current being used in various side reactions, including the metal corrosion due to the product generated by the partial decomposition of the electrolytic solution, and the dissolving of the nickel-based metallic components caused when the voltage is maintained (dissolution reaction).

### SUMMARY OF THE INVENTION

Accordingly, there is a need for a high-quality electrochemical cell that can suppress lowering of charge-discharge efficiency, and that can stably maintain the charge-discharge cycle characteristics over extended time periods:

Specifically, the present invention provides the following:

(1) According to an aspect of the present invention, there is provided an electrochemical cell that includes:
a sealing container that includes a base member, and a lid member welded to the base member is a weld layer, the base member and the lid member sealing and defining a storage space in between; and
a chargeable and dischargeable electrochemical element housed in the storage space and that includes a positive electrode, a negative electrode, and a separation member impregnated with a nonaqueous electrolytic solution,
wherein the positive electrode is electrically connected to the base member,
wherein the negative electrode is electrically connected to the lid member by being overlaid on the positive electrode via the separation member, and allows cations and/or anions to move between the positive electrode and the negative electrode through the nonaqueous electrolytic solution.
wherein the lid member is formed of a metallic material that contains nickel, and
wherein the negative electrode has a greater capacitance than the positive electrode.

According to the electrochemical cell of tie aspect of the present invention, applying a voltage between the positive electrode and the negative electrode causes cations and/or anions to move between the positive electrode and the negative electrode through the nonaqueous electrolytic solution for the charge and discharge.

Specifically, because the capacitance balance of the positive and negative electrodes is adjusted to make the capacitance of the negative electrode greater than the capacitance of the positive electrode, it is possible to make the slope of the potential changes on the negative, electrode side more gradual and closer to the reference potential (0 V), and to make the slope of the potential changes on the positive electrode side steeper relative to the reference potential during the charge and discharge, without changing the potential difference between the positive and negative electrodes.

The nickel disposed opposite the activated carbon containing various functional groups via the intervening electrolytic solution easily dissolves when exposed in the oxidative state to produce electrode potentials with a potential difference during the charge and discharge. However, because the capacitance balance of the positive and negative electrodes is adjusted to make the slope of the potential changes on the negative electrode side more gradual, it is possible to make the nickel dissolution range narrower, and to suppress nickel dissolution during the charge and discharge and prevent wasting current.

Further, the electrolytic solution undergoes a reductive decomposition reaction on the negative electrode side according to the potential during the charging process. The products generated by the reductive decomposition of the electrolytic solution diffuse in the sealing container (inside the cell) during the discharge, and contribute to the dissolution reaction of the collector. However, in the aspect of the present invention, because the negative electrode has a greater capacitance than the positive electrode, the lower limit of the potential on the negative electrode side shifts to the positive (higher) side even when the charge voltage (cell voltage) exceeds, for example, 2.7 V. This suppresses the reductive decomposition of the electrolytic solution at the negative electrode. Specifically, it is possible to suppress the generation of the decomposition product that contributes to metal oxidation.

As a result, lowering of charge-discharge efficiency can be suppressed, and the charge-discharge cycle characteristics can be stably maintained over extended time periods. A high-quality electrochemical cell can thus be provided. Further, because the decomposition of the electrochemical solution and nickel dissolution can be suppressed, the charge voltage can be stably maintained at a high voltage of 2.7 V or more even when, for example, sulfolane is used for the nonaqueous electrolytic solution.

(2) In the electrochemical cell according to the aspect of the present invention, it is preferable that the capacitance of the negative electrode be greater than the capacitance of the positive electrode by a factor of from 1.13 to 2.

In this case, because the capacitance or the negative electrode is greater than the capacitance of the positive electrode, by a factor of al least 1.13, the potential on the negative electrode side can vary along a distinctly gradual slope, and the lower limit of the negative electrode potential can be shifted to the positive (higher) side even when, for example, the charge voltage (cell voltage) exceeds 2.7 V. This makes it possible to suppress the reductive decomposition of the electrolytic solution at the negative electrode, and thus the generation of by-products, and the oxidative nickel dissolution can be effectively suppressed.

Further, because the capacitance of the negative electrode is at most twice as large as the capacitance of the positive electrode, the slope of the positive electrode potential can be prevented from becoming too steep and the positive electrode potential can he prevented from overly increasing. Generally, an excessively high electrode potential on the positive electrode side causes the solvent of the nonaqueous electrolytic solution to easily undergo side reactions such as oxidative decomposition and polymerization. Such side reactions can be suppressed when the capacitance of the negative electrode is at most twice as large as the capacitance of the positive electrode.

By setting the capacitance balance of the positive electrode and the negative electrode in the foregoing range, it is possible to effectively suppress the reductive decomposition of the solvent in the nonaqueous electrolytic solution and nickel dissolution, and to suppress the solvent of the nonaqueous electrolytic solution from overly decomposed by oxidation.

(3) In the electrochemical cell according to the aspect of the present invention, it is preferable that the negative electrode have a larger specific surface area than the positive electrode.

In this case, the capacitance balance of the positive electrode and the negative electrode can be easily and accurately changed only by the simple procedure of varying the specific surface area. This ensures that the foregoing effects (suppressing the reductive decomposition of the electrolytic solution, and suppressing the nickel dissolution during the charge and discharge) are more reliably obtained.

Note that the surface of the activated carbon forming the electrodes is etched by activation treatment, and has large numbers of irregularities. It is therefore required to increase the specific surface area with mesopores (2 to 50 nm) and micropores (50 nm or more) that contribute to the charge and discharge capacity.

(4) In the electrochemical cell according to the aspect of the present invention, it is preferable that the positive electrode include activated carbon subjected to a steam-activated surface treatment, and that the negative electrode include activated carbon subjected to an alkali-activated surface treatment.

In this case, by changing the surface treatment of the activated carbon for the positive electrode and the negative electrode, the pore size of the activated carbon adsorbing cations and/or anions can be varied, and the balance of the specific surface area can be changed for the positive and negative electrodes. This is particularly advantageous in terms of reducing the cost of forming the electrodes, because the material of the activated carbon does not need to be changed.

(5) In the electrochemical cell according to the aspect of the present invention, it is preferable that the negative electrode and the positive electrode include activated carbon of the same material subjected to the same surface treatment, and that the negative electrode have a smaller density than the positive electrode.

In this case, by varying the electrode density, the positive and negative electrodes are impregnated with different amounts of the nonaqueous electrolytic solution. The increased or decreased solution resistance varies the overvoltage, and the same effect obtained by varying the balance of the electrode specific surface area can be developed. This is advantageous in terms of further reducing the cost of forming the electrodes, because the material of the activated carbon and the surface treatment do not need to he changed.

(6) In the electrochemical cell according to the aspect of the present invention, it is preferable that the nonaqueous electrolytic solution contain sulfone as a solvent.

In this case, because the solvent of the nonaqueous electrolytic solution contains at least sulfone, decomposition due to oxidation and reduction does not easily occur, and it is easy to increase the withstand voltage during the charge and discharge that involves a potential difference of, for example, 2.7 V or more, as compared with known cyclic carbonates such as propylene carbonate and ethylene carbonate used in the related art.

Note that the gas components generated by the electrochemical decomposition of the cyclic carbonate include carbon dioxide gas, and hydrocarbons such as alkane and alkene. Thus, when cyclic carbonates such as propylene carbonate are used as the solvent of the electrolytic solution and a voltage of 2.7 V or more is applied, the gas fills the sealing container and increases the internal pressure before it breaks the container. It is therefore desirable to use an electrolytic solution that contains a cyclic sulfone such as sulfolane as the solvent in devices, that involve an applied voltage of 2.7 V or more. The sulfolane is unlikely to cause decomposition under applied voltage, and generates only a slight amount of a decomposition product that contains only a few gas components. It is therefore desirable to use sulfolane as the solvent when the sealing container according, to the aspect of the present invention is used in capacitors or other devices that involve an applied voltage of 2.7 V or more.

This makes it possible to set the capacitance balance and make the slope of potential changes steeper on the positive electrode side, and more gradual on the negative electrode side. It is therefore possible to more effectively suppress the side reactions that occur during the charge and discharge, including the reductive decomposition reaction of the solvent on the negative electrode side, and the nickel dissolution caused by the product of the decomposition reaction.

(7) In the electrochemical cell according to the aspect of the present invention, it is preferable that the sulfone be a cyclic sulfone, and that the capacitance of the negative electrode be set to be greater than the capacitance of the positive electrode so that decomposition of the cyclic sulfone upon charging generates tetrahydrothiophene in 10 ppm or less.

In this case, because the amount of the tetrahydrothiophene produced by the reductive decomposition reaction does not exceed 10 ppm, the various side reactions caused by the increase of the tetrahydrothiophene can be minimized,

When the solvent contains a cyclic sulfone (sulfolane), the amount of the product tetrahydrothiophene increases a the reductive decomposition reaction proceeds further during the charging process. However, because the tetrahydrothiophene amount is kept low at 10 ppm or less by setting the capacitance balance between the positive and negative electrodes, the decomposition of the electrolytic solution can be suppressed even more effectively. This makes it easier to have a high charge voltage of 2.7 V or more.

The present invention can therefore provide a high-quality electrochemical cell that can suppress lowering of charge-discharge efficiency, and that can stably maintain the charge-discharge cycle characteristics over extended time periods.

### BRIEF DESCRIPTION OF THE DRAWINGS

FIG. 1 is a longitudinal sectional view of a chip-type electric double-layer capacitor according to an embodiment of the present invention.

FIG. 2 is a diagram representing voltage changes during the charge and discharge of an electric double-layer capacitor of the related art.

FIG. 3 is a diagram representing voltage changes during the charge and discharge of the electric double-layer capacitor shown in FIG. 1.

FIG. 4 is a longitudinal sectional view illustrating a variation of the electric double-layer capacitor shown in FIG. 1.

FIG. 5 is a longitudinal sectional view illustrating another variation of the electric double-layer capacitor shown in FIG. 1.

FIG. 6 is a longitudinal sectional view illustrating yet another variation of the electric double-layer capacitor shown in FIG. 1.

### DETAILED DESCRIPTION OF THE PREFERRED EMBODIMENTS

An embodiment of an electrochemical cell according to the present invention is described below with reference to the accompanying drawings.

Note that, in the present embodiment, a surface-mounted electric double-lover capacitor having a substantially cuboidal chip-shaped exterior is described as an example of the electrochemical cell.

### Configuration of Electric Double-Layer Capacitor

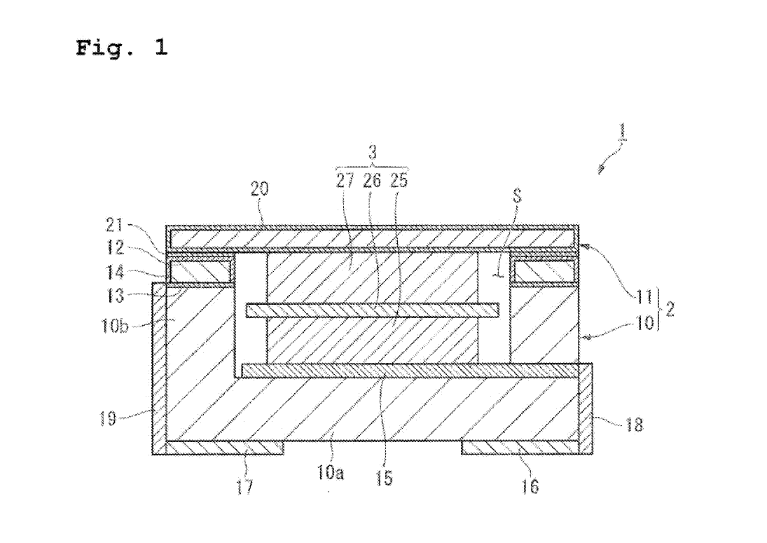

As illustrated in FIG. 1, an electric double-layer capacitor 1 includes a sealing container 2 having a storage space S sealed therein, and a chargeable-dischargeable electrochemical element 3 housed inside the storage space S and that includes a positive electrode 25 and a negative electrode 27 impregnated with nonaqueous electrolytic solution (not illustrated). The electric double-layer capacitor 1 is surface-mountable on a substrate (not illustrated) by, for example, a reflow process.

The sealing container 2 includes a container main body (base member) 10, and a sealing plate (lid member) 11 welded to the container main body 10 via a sealing ring 12 (described later). The container main body 10 is formed of material such as ceramic and glass, and has a form of a depressed, bottomed cylindrical container with a plate-shaped bottom wall portion 10a and a frame-shaped peripheral wall portion 10b. The depression is defined by the bottom wall portion 10a and the peripheral wall portion 10b, and is closed and sealed by the sealing plate 11.

More specifically, a joint layer 13 is formed on the top surface of the peripheral wall portion 10b of the container main body 10 so as to radially surround the outer side of the depression. The sealing ring is fastened to the container main body 10 via the joint layer 13. For example, a brazing filler metal (such as Ag—Cu alloy) may be used as the joint layer 13.

The sealing plate 11 is overlaid on the sealing ring 12, and is firmly welded to the sealing ring 12 via a weld layer 21. The welding may be performed by seam welding that involves contacting with a roller electrode, or by laser welding or ultrasonic welding.

In this way, the sealing plate 11 is joined air-tight to the container main body 10 via the sealing ring 12. The storage space S is the space sealed and defined by the depression of the container main body 10 and the sealing plate 11.

In the present embodiment, the sealing ring 12 is formed of a metallic material that contains nickel. Specifically, the metallic material is one selected from kovar (an alloy of Co: 17 weight %, Ni: 29 weight %, and Fe: the remaining part), elinvar (an alloy of Co: 12 weight %. Ni: 36 weight %, and Fe: the remaining part), inver (an alley of Ni: 36 weight %, and Fe: the remaining part), and a 42-alloy (an alloy of Ni: 42 weightN, and Fe: the rernamirw part). However, the metallic material is not limited to these

Particularly preferably, the material of the sealing ring 12 is one that has a thermal expansion coefficient close to that of the container main body 10. For example, when the container main body 10 is formed by using an alumina having a thermal expansion coefficient of 6.8×10⁻⁶/° C. the sealing ring 12 is preferably made of materials such as a kovar having a thermal expansion coefficient of 5.2×10⁻⁶/° C., a 42-alloy having a thermal expansion coefficient of 4.5 to 6.5×10⁻⁶/° C., and a nickel base alloy.

The sealing plate 11 of the present embodiment is also made of a nickel-containing metallic material, as with the sealing ring 12. Specifically, one selected from kovar, elinvar, inver, and a 42-alloy is used. Preferably, the material has a thermal expansion coefficient close to that of the container main body 10.

In the present embodiment, the sealing ring 12 and he sealing plate 11 are surface-coated with a plating layer 14 and a plating layer 20, respectively.

Examples of the plating layers 14 and 20 respectively coating the sealing ring 12 and the sealing plate 11 include noble metals, such as nickel and gold, having excellent corrosion resistance. The plating layers 14 and 20 may be monolayer films, or laminated films of a base layer and a finishing layer,

The plating layers 14 and 20 may be formed by, for example, electrolytic plating or non-electrolytic plating, or by using a vapor phase method such as vacuum vapor deposition,

When welding the sealing plate 11, at least one of the plating layer 20 of the sealing plate 11 and the plating layer 14 of the sealing ring 12 melts and forms the weld layer 21. The melting desirably blends the sealing plate 11 and the sealing ring 12 together and firmly joins these members.

Note that the weld layer 21 may be formed by the melting of both of or only one of the plating layers 14 and 20. However, in the case of seam welding, it is preferable to form the add layer 21 by melting the plating layer 14 of the sealing ring 12 from the standpoint of preventing fouling or other undesirable effects on the roller electrode.

It is accordingly necessary that the plating layer 14 of the sealing ring 12 and the plating layer 20 of the sealing plate It be formed at least on the opposing portions of the sealing ring 12 and the scaling plate 11 to realize the welding of the sealing plate 11 via the weld layer 21.

Note that the plating layer 20 coating the sealing plate 11 is in contact with the negative electrode 2 (described later), and also serves as the collector of the negative electrode 27.

A collector 15 is formed over substantially the whole area on the top surface, of the bottom wall portion 10a of the container main body 10 tracing the storage space S. On the bottom surface of the bottom wall portion 10a of the container main body 10, a pair of external connection terminals 16 and 17 is formed by being electrically separated from each other.

The external connection terminal 16 is conducted to the collector 15 via a side electrode 18 formed on a side surface of the container main body 10, whereas the other external connection terminal 17 is conducted to the joint layer 13 via a side electrode 19 formed on a side surface of the container main body 10,

More specifically, the collector 15 extends to the side surface of the container main body 10 where the external connection terminal 16 is formed. The side electrode 18 is formed on the side surface of the bottom wall portion 10a of the container main body 10 so as to connect the external connection terminal 16 to the collector 15 extending to the side surface of the container main body 10. On the other hand, the side electrode 19 is formed over the side surface of the bottom wall portion 10a and the peripheral wall portion 10b of the container main body 10 so as to connect the external connection terminal 17 to the joint layer 13 formed on the top surface of the peripheral wall portion 10b of the container main body 10.

The pair of external connection terminals 16 and 17, and the side electrodes 18 and 19 are formed as monolayer films of a single metal formed by methods, for example, such as plating and sputtering, or as laminated films of different metals. The laminated film may include two or three layers. However, it is preferable to use noble metals having excellent corrosion resistance, for example, such as nickel (for the base layer), and gold (for the surface layer), in order to perform a desirable reflow process with the substrate.

Preferably, tungsten, silver, and gold are used for the collector 15, because these metals have excellent corrosion resistance, and can be formed by using a thick film forming method. Further, in order to prevent dissolving in a nonaqueous electrolytic solution upon applying a positive potential, a valve metal (valve action metal; metal that generates a corrosion resistant passive film on the surface) or carbon may be used to form the collector 15.

Examples of the valve metal include aluminum, titanium, tantalum, niobium, and zirconium, and aluminum and titanium are particularly preferred.

Preferably, a chromium layer is used as the base layer, and the collector 15 is formed on this chromium base layer. The adhesion of the collector 15 for the container main body 10 can be improved by forming the base layer. Aside from the chromium laser, a titanium layer may preferably be used as the base layer. The titanium layer may be used riot only as the base layer, but as the collector 15 itself.

When carbon is used, materials such as graphite and amorphous carbon may be used as a conductive paste, and appropriately mixed with resin material at any proportions. The mixture can then be applied, dried, and solidified.

The electrochemical element 3 includes the positive electrode 25 electrically connected to the bottom wall portion 10a of the container main body 10 via the collector 15, and the negative electrode 27 disposed on the positive electrode 25 via a separator (separation member) 26: and that allows cations (such as lithium ions) or anions to move between the positive electrode 25 and the negative electrode 27 through a nonaqueous electrolytic solution.

As mentioned above, the positive electrode 25, the negative electrode 27, and the separator 26 are impregnated with a nonaqueous electrolytic solution (not illustrated).

The positive electrode 25 and negative electrode 27 are polarizable electrodes that allow for movement of cations or anions therebetween through the nonaqueous electrolytic solution, and that are capable of adsorbing and desorbing the cations or anions. For example, the positive electrode 25 and negative electrode 27 are produced by mixing activated carbon, a conductive material, and a binder such as polytetrafluoroethylene in predetermined proportions, and molding the mixture under a predetermined pressure. Specifically, activated carbon, a conductive auxiliary agent, and polytetrafluoroethylene may be mixed at a 9:1:1 ratio, kneaded, and press-rolled before cut into a desired size to produce the electrode,

In the present embodiment, the capacitance balance of the positive and negative electrodes 25 and 27 are adjusted to make the capacitance of the negative electrode 27 greater than the capacitance of the positive electrode 25. Specifically, the capacitance of the negative electrode 27 is adjusted to exceed the capacitance of the positive electrode 25 by a factor of from 1.13 to 2.

For conduction, the positive electrode 25 is fixed onto the collector 15 with a conductive adhesive or the like (not illustrated). The positive electrode 25 is thus conducted to the external connection terminal 16 via the collector 15 and the side electrode 18. The sheet-like separator 26 and the negative electrode 27 are laminated in this order on the positive electrode 25. The negative electrode 27 is in contact with the bottom surface of the scaling plate 11 via the plating, layer 20 serving as a collector and is conducted to the plating layer 20. The negative electrode 27 is thus conducted to the external connection terminal 17 via the plating layer 20, the sealing ring 12, the joint layer 13, and the side electrode 19.

The separator 26 is a member that separates the positive electrode 25 and the negative electrode 27 from each other to restrict the positive and negative electrodes 25 and 27 from directing contacting each other. Further, the separator 26 is designed to prevent the contact and the electrical shorting, of the positive and negative electrodes 25 and 27 and/or impact or some other external force. The thickness of the separator 26 is the distance between the positive electrode 25 and the negative electrode 27.

The nonaqueous electrolytic solution is, for example, an electrolytic solution prepared by using a quaternary all such as a TEABF₄ salt as a supporting salt after removing the water content, and dissolving the salt in an aprotic polar organic solvent in which the water content has been brought to 100 ppm or less by removal. The electrolytic solution may be present in the storage space S by impregnating at least the positive electrode 25, the negative electrode 27, and the separator 26.

It is particularly preferable that the water content of the nonaqueous electrolytic solution is adjusted beforehand to, for example, 20 ppm or less.

### Effects of Electric Double-Layer Capacitor

In the electric double-layer capacitor 1 configured as above, anions and cations move toward the positive electrode 25 and the negative electrode 27, respectively, through the nonaqueous electrolytic solution upon applying a voltage across the positive electrode 25 and the negative electrode 27 via the pair of external connection terminals 16 and 17. The anions and cations are adsorbed as they form electric double-layers on the respective activated carbon surfaces during the charging process, and are desorbed during the discharge as the electric double-layers disappear. The charge and discharge occur in this fashion through the accumulation and the release of the charges.

Specifically, the anions solvated by the supporting salt are adsorbed on the positive electrode 25 side, whereas the solvated cations are adsorbed on the negative electrode 27 side during the charging process. As a result, electric double-layers are formed on the positive and negative electrodes 25 and 27. In this manner, the electric double-layer capacitor 1 enables the charges to be stored only through the physical adsorption of the ions without reactions that involve oxidation and reduction, and is therefore more stable than chemical batteries that involve oxidation and reduction.

The electric double-layer capacitor 1 of the present embodiment may be surface-mounted on a substrate with, for example, the external connection terminal hi and the external connection terminal 17 used as the positive electrode terminal and the negative electrode terminal, respectively. In this way, the electric double-layer capacitor 1 can be used as a backup power supply for the memory and the clock of devices such as housing equipment, transporters such as automobiles, and cell phones. The electric double-layer capacitor 1 also can be preferably used as a backup power supply for the memory of devices such as laptop personal computers, cordless telephones, headphone stereos, video cameras, digital cameras, portable electronic dictionaries, calculators, memory cards, PDAs, and portable gaming machines, and as a backup power supply for the functions of GPS-installed devices,

In the electric double-layer capacitor 1 of the present embodiment, the sealing ring 12 and the sealing plate 11 contain nickel and are formed of metallic materials having thermal expansion coefficients close to the thermal expansion coefficient of the container main body 10. The sealing ring 12 and the sealing plate 11 can thus be firmly joined to each other with high compatibility. This ensures that the sealing plate 11 is reliably welded to he container main body 10 via the sealing ring 12, and a high-quality capacitor can be produced that tightly seals the storage space S without causing entry of the moisture or the like from the atmosphere.

Further, because the capacitance balance of the positive and negative electrodes 25 and 27 is adjusted to make the capacitance of the negative electrode 27 greater than the capacitance of the positive electrode 25, it is possible to make the slope of the potential changes on the negative electrode 27 side more gradual and closer to the reference potential (0 V), and to make the slope of the potential changes on the positive electrode 25 side steeper relative to the reference potential during the charge and discharge, without changing the potential difference (charge voltage) between the positive and negative electrodes 25 and 27.

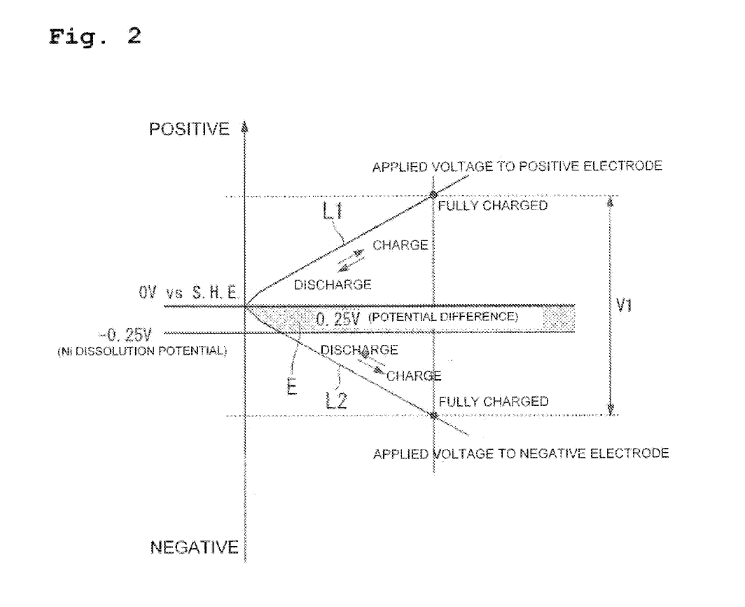

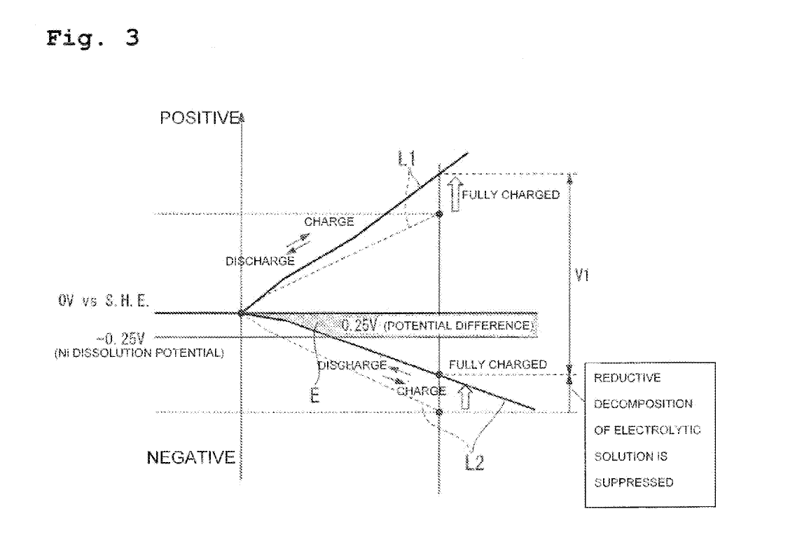

This is described below with reference to FIGS. 2 and 3.

FIGS. 2 and 3 represent voltage changes during the charge and discharge. A standard hydrogen electrode (vs. SHE) represents the reference potential. FIG. 2 represents voltage changes in a common electric double-layer capacitor. FIG. 3 represents voltage changes in the electric double-layer capacitor 1 of the present embodiment.

As represented in FIG. 2, in a common electric double-layer capacitor, the positive electrode potential varies along slope L1, and the negative electrode potential varies along slope L2 under constant current (CC) charge and discharge. The potential difference between the two electrodes is the charge voltage V1 during the charging process. The metal nickel disposed opposite the activated carbon containing various functional groups via the intervening electrolytic solution easily dissolves when exposed in the oxidative state to produce electrode potentials with a potential difference (for example, −0.25 V) during the charge and discharge.

When the charge voltage V1 is 2.7 V or more, the negative electrode potential may drop to about 1.3 V or less relative to the standard hydrogen electrode (vs. SHE), and the adverse effects of the reductive decomposition of the electrolytic solution components become more likely. Specifically, the supporting salt and the solvent of the electrolytic solution become susceptible to reductive decomposition, and generate products that promote metal corrosion. The sulfone contained in the solvent also becomes susceptible to decomposition, and generates metal corrosion-promoting products,

In the electric double-layer capacitor 1 of the present embodiment, however, because the capacitance balance is adjusted to make the capacitance of the negative electrode 27 greater than the capacitance of the positive electrode 25, the slope L2 of the potential changes on the negative electrode 27 side can be made more gradual, and the slope L1 of the potential changes on the positive electrode 25 side can be made steeper, as represented in FIG. 1. This makes it possible to make the nickel dissolution range E narrower than the common range (see FIG. 2) while maintaining the charge voltage V1, and to suppress nickel dissolution during the charging process and prevent wasting current. The decomposition of the nonaqueous electrolytic solution also can be suppressed.

It is therefore possible to suppress lowering of charge-discharge efficiency, and to stably maintain the charge-discharge cycle characteristics over extended time periods. The capacitor can thus have high quality also in this respect. Further, because the decomposition of the nonaqueous electrolytic solution and nickel dissolution can be suppressed, a stable operation is possible even with a high charge voltage V1 of 2.7 V or more.

Specifically, because the capacitance of the negative electrode 27 is greater than the capacitance of the positive electrode 25 by a factor of at least 1.13 in this embodiment, the potential on the negative electrode 27 side can vary along a distinctly gradual slope L2, and nickel dissolution can be suppressed more effectively.

Further, because the capacitance of the negative electrode 27 is at roost twice as large as the capacitance of the positive electrode 25, it is possible to prevent the slope L1 of the potential en the positive electrode 25 side from becoming too steep and overly increasing the potential on the positive electrode 25 side.

Typically, an excessively high potential on the positive electrode 25 side tends to cause a side reaction that decomposes the solvent of the nonaqueous electrolytic solution. The decomposition reaction produces unwanted products. [For example, when PC (propylene carbonate) is used for the solvent, a polymerized product generates by polymerization reaction on the positive electrode 25 side, and gases such as CO₂ generate on the negative electrode 27 side. The gases accumulate in the sealing container 2 (inside the cell), and reduce the solid-liquid interface for the electrode reaction. This reduces the effective reaction area, and increases the overvoltage. Reactions involving oxidation and reduction also occur on the positive electrode 25 and the negative electrode 27 when the solvent uses sulfolane.] In this case, the charging energy used for the charge accumulation is used b the unintended side reactions during the charging process, and competes with the reactions that generate the foregoing products. The result is lowered current efficiency. Further, the products cause degradation of the electrodes and the collector 15, and lower the storage characteristics.

These decomposition reactions can be suppressed, and the undesirable effects of such reactions can be prevented when the capacitance of the negative electrode 27 is at most twice as large as the capacitance of the positive electrode 25, as above.

Specifically, by setting the capacitance balance of the positive electrode 25 and the negative electrode 27 in the foregoing range, the decomposition of the nonaqueous electrolytic solution and nickel dissolution can be effectively suppressed, and the solvent of the nonaqueous electrolytic solution can be suppressed from being decomposed to prevent lowering of current efficiency and storage characteristics.

In this embodiment, the capacitance balance is adjusted to make the capacitance greater On the negative electrode 27 side than on the positive electrode 25 side. This can be achieved by various methods.

For example, the specific surface area of the negative electrode 27 may be increased more than the specific surface area of the positive electrode 25. Specifically, the negative electrode 27 can have a larger specific surface area than the positive electrode 25 by varying the number of the pores of the activated carbon in the positive and negative electrodes 25 and 27 (pores that adsorb cations and anions; for example, 2 to 50-nm mesopores, and micropores having a size of 50 nm (or more).

As an example, the she of the activated carbon pores can be varied by varying the material of the activated carbon for the positive electrode 25 and the negative electrode 27. For example, a coconut husk may be used as the activated carbon material of the positive electrode 25, and a phenolic resin as the activated carbon material of the negative electrode 27 to provide a larger specific surface area for the negative electrode 27 than for the positive electrode 25.

It is also possible to use different surface treatments for the activated carbon. For example, the positive electrode 25 may be formed with activated carbon subjected to a steam-activated surface treatment, and the negative electrode 27 with activated carbon subjected to an alkali-activated surface treatment to provide a larger specific surface area for the negative electrode 27 than for the positive electrode 25. This method is advantageous in terms of reducing the cost of forming the electrodes, because the material of the activated carbon does not need to be changed.

The surface treatment is not limited to these, and various other surface treatments may be used. In this case, different surface treatments may be performed for the positive electrode 25 and the negative electrode 27.

Any of these methods can be used to easily and accurately change the capacitance balance of the positive electrode 25 and the negative electrode 27 by the simple procedure of varying the specific surface area. This ensures that the foregoing effects (preventing the decomposition of the nonaqueous electrolytic solution, particularly the reductive decomposition on the negative electrode side, and suppressing nickel dissolution during the charge and discharge) are more reliably obtained.

When the same material subjected to the same surface treatment is used for the activated carbon of the positive electrode 25 and the :activated carbon of the negative electrode 27, the density of the negative electrode 27 is reduced more than the density of the positive electrode 25. Specifically, the negative electrode 27 may be impregnated with smaller amounts of the nonaqueous electrolytic solution than is the positive electrode 25 to provide a larger specific surface area for the negative electrode 27 than for the positive electrode 25. In this way, the cost of forming, the electrodes can be reduced further, because the material of the activated carbon and the surface treatment do not need to be changed.

In this embodiment, the solvent of die nonaqueous electrolytic solution preferably contains sulfone.

In this ease, because the solvent of the nonaqueous electrolytic solution at least contains sulfone that contains sulfur (S), decomposition does not easily occur during the charge and discharge, and it is easy to increase the withstand voltage. In this way, the capacitance balance can be set to make the slope of the potential changes steeper the positive electrode 25 side and more gradual on the negative electrode 27 side, and the decomposition of the nonaqueous electrolytic solution and the nickel dissolution during the charge and discharge can be suppressed more effectively.

Examples of the sulfone include chain sulfones such as linear sulfones and branched sulfones, and cyclic sulfones (sulfolanes).

Examples of the chain sulfones include DMS (dimethylsulfone) of the general formula 1, EMS (ethylmethylsulfone) of the general formula 2, and i-PMS (isopropylmethylsulfone) of the general formula 3 below.

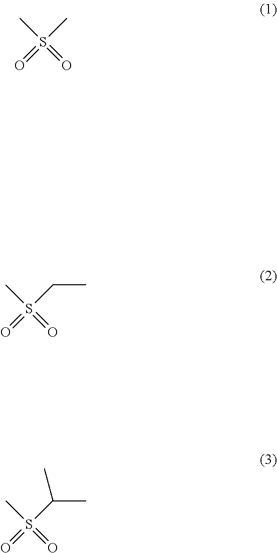

Examples of the cyclic sulfones include SL (sulfolane) of the general formula 4, and 3-MSL (3-methylsulfolane) or the general formula 5 below.

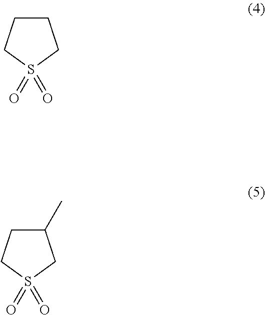

It is particularly preferable that the solvent of the nonaqueous electrolytic solution does not contain PC (propylene carbonate) commonly used in the art, and contains only sulfolane (SL). In this way, the withstand voltage can be increased more effectively.

Farther, in the present invention, activated carbon containing functional groups such as ═O, —OH, and —COOH can be used for the positive electrode 25 and the negative electrode 27, even when the solvent of the nonaqueous electrolytic solution contains sulfone. In this case the decomposition reaction of the sulfone can be suppressed, and the withstand voltage can be increased even when the activated carbon contains the oxygen-containing functional groups on the surface.

Further, the cyclic sulfolane may be used in combination with a low-melting-point solvent. The low-melting-point solvent is selected from polar solvents, because the solvent needs to be uniformly mixed and dispersed with the sulfolane. In this respect, the poor polarity hydrocarbons are not suitable. Alcohols are not suitable either, because alcohols have high chemical reactivity, and cause reactions such as the decomposition of the electrolytic solution and the adsorption of the electrolytic solution to the activated carbon, and inhibit the adsorption of ions by the activated carbon.

For these reasons, the low-melting-point solvent is preferably an aprotic polar solvent more preferably chain esters, chain others, glycol ethers, and chain carbonates, particularly preferably chain esters, and chain carbonates. Chain esters and chain carbonates are preferred, because these are stable under the applied voltage between the electrodes.

Examples of the chain esters include aliphatic monocarboxylic acid esters, including formic acid esters such as methyl formate (HCOOCH₃, MP: −99.8° C., BP: 31.8° C.), ethyl formate (HCOOC₂H₅, MP: −80.5° C., BP: 54.3° C.), propyl formate (HCOOC₃H₇, MP: −92.9° C., BP: 81.3° C.), n-butyl formate (HCOO(CH₂)₃CH₃, MP: −90° C., BP: 106.8° C.), isobutyl formate (HCOO(CH₂)CH(CH₃)₂, MP: −95° C., BP: 98° C.), and amyl formate (HCOO(CH₂)₄CH₃, MP: −73.5° C., BP: 130° C.): acetate esters such as methyl acetate (H₃CCOOCH₃, MP: −98.5° C., BP: 57.2° C.), ethyl acetate (H₃CCOOC₂H₅, MP: −82.4° C., BP: 77.1° C.), n-propyl acetate (H₃CCOO(CH₂)₂CH₃, MP: −92.5° C., BP: 101.6° C.), isopropyl acetate (H₃CCOO(CH)(CH₃), MP: −69.3° C., BP: 89° C.), n-butyl acetate (H₃CCOO(CH₂)₃CH₃, MP: −76.8° C., BP: 126.5° C., isobutyl acetate (H₃CCOO(CH₂)CH(CH₃)₂, MP: −98.9° C., BP: 118.3° C.), 2-butyl acetate (H₃CCOO(CH)(CH₃)(CH₂CH₃), MP: −99° C., BP: 112.5° C.), n-amyl acetate (H₃CCOO)(CH₂)₄(CH₃), MP: −75° C., BP: 147.6° C.), isoamyl acetate (H₃CCOO(CH₂)₂(CH)(CH₃)₂, MP: −78.5° C., BP: 142.5° C.), methyl isoamyl acetate (H₃CCOO(CH₂)(CH₃)(CH₂(CH)(CH₃)₂, MP: −63.8° C., BP: 146.3° C.), 2-hexyl acetate (H₃CCOO(CH)(CH₃)(CH₂)₃(CH₃), MP: −63.8° C., BP: 146.3° C.); propionate esters such as methyl propionate (H₃CCH₂COO(CH₃), MP: −87° C., BP: 79.7° C.), ethyl propionate (H₃CCH₂COO(C₂H₅), MP: −73.9° C., BP: 99.1° C.), n-butyl proprionate (H₃CCH₂COO(CH₂)₃CH₃, MP: −89.55° C., BP: 145.4° C.), isoamyl propionate (H₃CCH₂COO(CH₂)₂CH(CH₃)₂, MP: −73° C. BP: 160.3° C.); and butytic acid esters such as methyl butyrate (H₃C(CH₂)₂COO(CH₃), MP: −95° C, BP: 102.3° C.), ethyl butyrate (H₃C(CH₂)₂COO(CH₂)(CH₃), MP: −93.3° C., BP: 121.3° C.), n-butyl butyrate (H₃C(CH₂)₂COO(CH₂)₃(CH₃), MP: −91.5° C., BP: 166.4° C.), and isoamyl butyrate (H₃C(CH₂)₂COO(CH₂)₂(CH(CH₃)₂, MP: −73.2° C., BP: 184.8° C.).

Examples of the chain carbonates include diethyl carbonate (H₅C₂OCOOC₂H₅, MP: −43° C., BP: 127° C.), and ethyl methyl carbonate (H₅C₂OCOOCH₃, MP: −55° C., BP: 108° C.).

The low-melting-point solvent is preferably a fatty monocarboxylic acid ester, more preferably a propionate ester, further preferably methyl propionate, ethyl propionate, and propyl propionate. These low-melting-point solvents may be used either alone or in a combination of two or more.

In the foregoing embodiment, the plating Iayer 20 is formed on the sealing plate 11. However, the plating layer 20 is not necessarily required, and the sealing plate 11 may be directly welded to the of container main body 10 via the sealing ring 17 without being provided with the plating layer 20. It is, however, preferable to coat the sealing plate with the plating layer 20.

Further, the sealing ring 12, fastened via the joint layer 13 in the foregoing embodiment, may be directly brazed on the peripheral wall portion 10b of the container main body 10. In this case, the side electrode 19 may be conducted to the sealing ring 12.

Further, the material of the container main body 10, described as being, for example, ceramic or glass in the foregoing embodiment may be more specifically ceramic materials, for example, such as alumina HTCC (High Temperature Co-fired Ceramic), and glass ceramic LTCC (Low Temperature Co-fired Ceramic).

The glass material may be, for example, soda-lime glass, lead glass, or borosilicate glass, of which borosilicate glass is more preferred considering processibility.

Further, in the foregoing embodiment, the collector 15 and the external connection terminal 16 are conducted to each other via the side electrode 18, and the joint layer 13 and the external connection terminal 17 are conducted to each other via the side electrode 19. However, the invention is not limited to this.

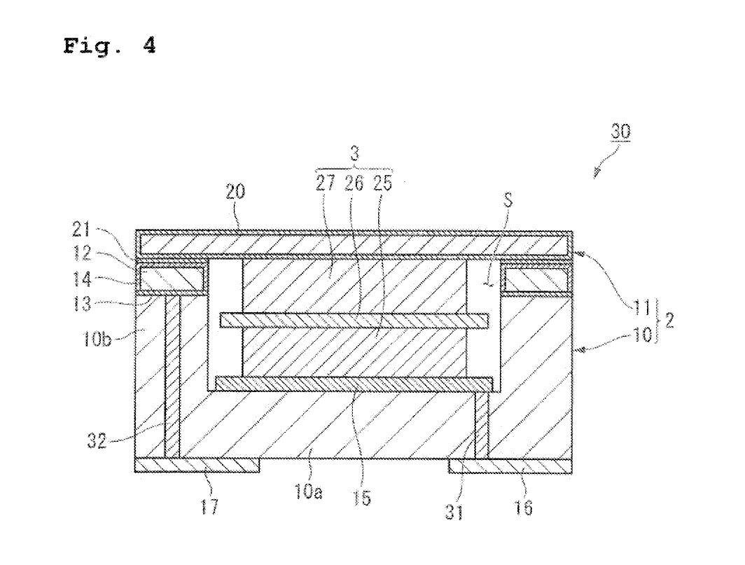

For example, as illustrated in FIG. 4, the collector 15 and the external connection terminal 16 may be conducted to each other via a first through electrode 31, and the joint layer 13 and the external connection terminal 17 may be conducted to each other via a second through electrode 32, as described below in detail.

In this case, the collector 15 is formed on the bottom wall portion 10a of the container main body 10, inside the storage space S. The first through electrode 31 is formed vertically through the bottom wall portion 1 0a of the container main body 10, and the collector 15 is conducted to one of the external connection terminal 16. On the other hand, the second through electrode 32 is formed vertically through the bottom wall portion 10a and the peripheral wall portion 10b of the container main body 10, and the joint layer 13 is conducted to the external connection terminal 17.

The only difference of an electric double-layer capacitor 30 configured as above is the way the pair of external connection terminals 16 and 17 and the collector 15 and the joint layer 13 are interconnected, and the electric double-layer capacitor 30 can have the same advantages, and can be used as a surface-mounted capacitor.

Further, the through electrodes and the side electrodes may be combined to conduct the collector 15 to the external connection terminal 16, and the joint layer 13 to the other external connection terminal 17.

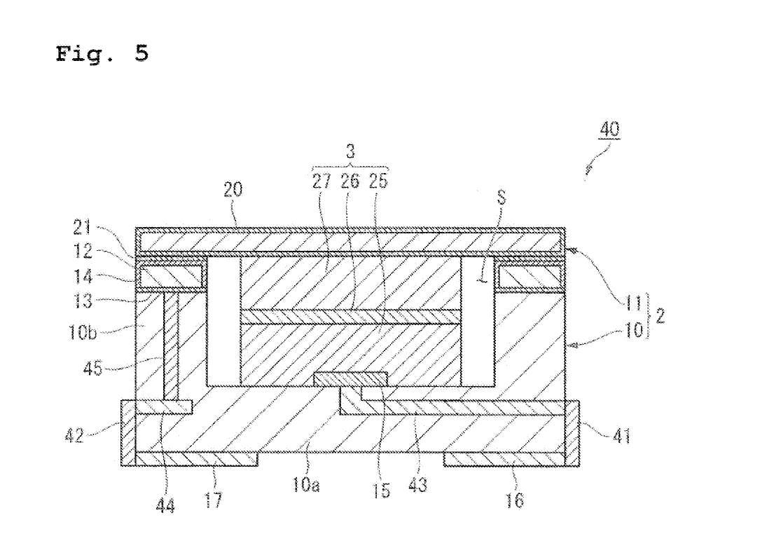

For example, as illustrated in FIG. 5, a collector 15 having a smaller transverse sectional area than the positive electrode 25 is formed at substantially the center of the positive, electrode 25 on the bottom wall portion 10a of the container main body 10, and the collector 15 and a side electrode 41 are connected to each other by using an inner electrode, 43 formed in the bottom wall portion 10a. Further, a through electrode 45 conducted to the joint layer 13 is formed halfway through the bottom wall portion 10a, and is connected to a side electrode 42 by using an inner electrode 44 formed in the bottom wall portion 10a.

In this way, the collector 15 can be conducted to the external connection terminal 1 via the inner electrode 43 and the side electrode 41. Further, the joint layer 13 can be connected to the external connection terminal 1 via the through electrode 45, the inner electrode 44, and the side electrode 42.

The only difference of an electric double-layer capacitor 40 configured as above is the way the pair of external connection terminals 16 and 17 and the collector 15 and the joint layer 13 are interconnected, and the electric double-layer capacitor 40 can have the same advantages, and can he used as a surface-mounted capacitor.

Further, in the foregoing embodiment, the bottomed cylindrical container main body 10 is used as the base member, and the plate-shaped sealing plate 11 is used as the lid member. However, the invention is not limited to this, and the base member and the lid member may be formed into any shapes, provided that the sealed storage space S is defined between the base member and the lid member.

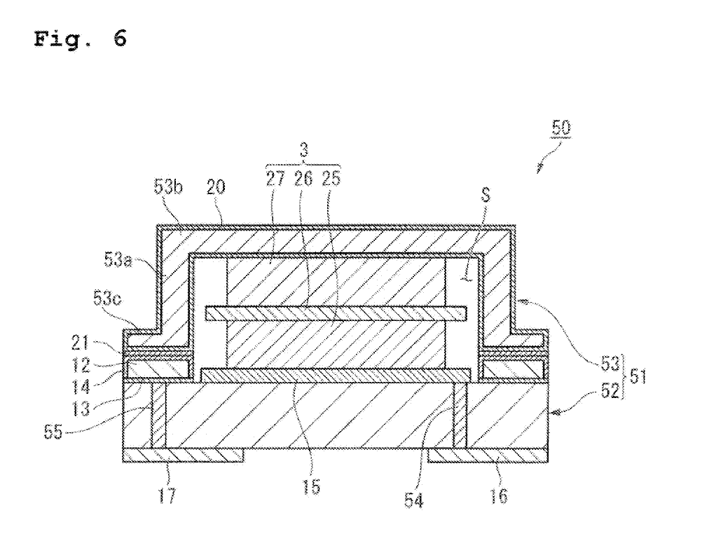

For example, as illustrated in FIG. 6, a sealing container 51 may be provided that uses a plate-shaped base substrate 52 as the base member, and a capped cylindrical lid unit 53 as the lid member.

For example, a first through electrode 54 and a second through electrode 55 are formed through the base substrate 52. The first through electrode 54 conducts the collector 15 to the external connection terminal 16. The second through electrode 55 conducts the joint layer 13 to the external connection terminal 17.

The lid unit 53 includes a cylindrical peripheral wall portion 53a, a top wall portion 53b continuously provided from the upper end portion of the peripheral wall portion 53a and that closes the peripheral wall portion 53a, and a flange portion 53c continuously provided from the lower end portion of the peripheral wall portion 53a and that extends outwardly along the radial direction of the peripheral wall portion 53a. The flange portion 53c overlies the base substrate 52 is the scaling ring 12.

The lid unit 53 is fixed onto the base substrate 52 by being welded with the sealing ring 12. Here, the storage space S is defined by the base substrate 52, and the peripheral all portion 53a and the top wall portion 53b of the lid unit 53. The plating, layer 20 is formed on the inner surface of the lid unit 53.

The only difference of an electric double-layer capacitor 50 configured as above is the shape of the sealing container 51, and the electric double-layer capacitor 50 can have the same advantages, and can be used as a surface-mounted capacitor.

It should be noted that the technical scope of the present invention is not limited to the foregoing embodiment, and may be modified in many ways provided that such modifications to not deviate from the gist of the present invention.

For example, the electric double-layer capacitor 1 described as being an example of an electrochemical cell in the foregoing embodiment is not limited to this example. The electric double-layer capacitor 1 also may be used for an electrochemical device that involves redox reaction. For example, the electric double-layer capacitor 1 may be used as a lithium ion capacitor in which a material capable of storing and releasing metal lithium ions are used as the active material of the positive or negative electrode, or as a lithium secondary battery that uses an alloy of lithium metal and other metals such as aluminum and tin. Specifically, the invention is also applicable to lithium ion capacitors and lithium ion secondary batteries in which carbon material or silicon material capable of storing lithium ions is used as the negative electrode active material by being doped with lithium ions in advance, and to lithium ion capacitors in which an electrode such as the activated carbon used in an electric double-layer capacitor or the like is used in combination with at least one of the positive electrode and the negative electrode.

### EXAMPLES

The following describes examples in which evaluation tests were conducted to confirm the effects of the present invention.

Specifically, a nickel-plated kovar sealing plate was welded to a ceramic container main body via a nickel-plated kovar sealing ring to produce an electrochemical cell that contained an electrochemical element. The electrochemical element included a positive electrode and a negative electrode impregnated with a nonaqueous electrolytic solution, and was sealed in the storage space of the electrochemical cell.

The method used in the evaluation test is described first.

The charge and discharge were performed under constant current (CC) and constant voltage (CV). Specifically the charge was started under constant current, and the voltage was held for a certain time period upon reaching the highest voltage. Here, the total of the charge time and the hold time was set to 2 hours. After the lapse of 2 hours, the discharge was started under constant current, and the voltage was held for a certain time period upon reaching the lowest voltage (0 V). The total of the discharge time and the hold time was set to 1 hour.

This cycle of charge and discharge was repeated 120 times.

As to the temperature conditions of the electrochemical cell for the charge and discharge, a predetermined temperature, specifically 70±3° C. was set to avoid the nonaqueous electrolytic solution from being overly decomposed. Note that the temperature was appropriately varied to room temperature (25±3° C.) during the repeated cycles.

In the repeated 120 cycles of charge and discharge performed under the foregoing conditions, the capacitance [electrical capacitance (μAh) used for the charging] was monitored to evaluate the stability of the charge-discharge cycle characteristics.

Specifically, the cumulative capacitance value obtained from the current value rapidly varies when the leak current increase caused by the decomposition of the nonaqueous electrolytic solution or by nickel dissolution during the charge and discharge is greater than the charge current by 100% or more (when the current value doubled). Thus, it was determined that a leak current increase was “present”, and the charging was abnormal when the capacitance value showed such large changes. On the other hand, it was determined that a leak current increase was “absent”, and the charge-discharge cycle characteristics were stable when there were no large capacitance changes and the capacitance value showed smooth transitions at predetermined values,

### First Evaluation Test

A positive electrode and a negative electrode were produced by using activated carbon from coconut husk after a steam-activated surface treatment. A evaluation test was conducted while the capacitance balance of the positive and negative electrodes was appropriately varied by varying the outer dimensions (including thickness and length) of the activated carbon. The results are presented in Table 1.

In Table 1. Test Examples 1 to 3, and 5 to 7 represent examples of the present invention in which the negative electrode had a greater capacitance than the positive electrode. Test Examples 4 and 8 represent comparative examples in which the positive electrode had a greater capacitance than the negative electrode.

TABLE 1
Increase in leak current (100% or more)

| | | | | | | | Cycle test under maintained | | |
|---|---|---|---|---|---|---|---|---|---|
| | | | | | Negative/positive | Specific surface | constant voltage (70° C.) | | |
| | | Activated | Activation | Capacitance | capacitance | area ratio | 40 | 80 | 120 |
| | Electrode | carbon | method | (F/electrode) | balance (−) | (negative/positive) | cycles | cycles | cycles |
| Test Ex. 1 | Positive electrode | Activated | Steam | 0.0038 | 145 | 1.44 | Absent | Absent | Absent |
| | Negative electrode | carbon | activation | 0.0054 | | | | | |
| Test Ex. 2 | Positive electrode | from coconut | | 0.0051 | 133 | 1.33 | Absent | Present | Present |
| | Negative electrode | husk | | 0.0054 | | | | | |
| Test Ex. 3 | Positive electrode | | | 0.0045 | 121 | 1.21 | Absent | Present | Present |
| | Negative electrode | | | 0.0054 | | | | | |
| Test Ex. 4 | Positive electrode | | | 0.0062 | 88 | 0.88 | Present | Present | Present |
| | Negative electrode | | | 0.0054 | | | | | |
| Test Ex. 5 | Positive electrode | | | 0.0033 | 186 | 2.26 | Absent | Absent | Absent |
| | Negative electrode | | | 0.0062 | | | | | |
| Test Ex. 6 | Positive electrode | | | 0.0036 | 171 | 2.08 | Absent | Absent | Absent |
| | Negative electrode | | | 0.0062 | | | | | |
| Test Ex. 7 | Positive electrode | | | 0.0054 | 113 | 1.38 | Absent | Absent | Absent |
| | Negative electrode | | | 0.0062 | | | | | |
| Test Ex. 8 | Positive electrode | | | 0.0077 | 80 | 0.97 | Present | Present | Present |
| | Negative electrode | | | 0.0062 | | | | | |

As is clear from Table 1, a leak current increase (abnormal charging) due to the decomposition of the nonaqueous electrolytic solution and nickel dissolution occurred before 40 cycles when the positive electrode had a greater capacitance than the negative electrode. In contrast, a leak current increase was not observed at 40 cycles when the negative electrode had a greater capacitance than the positive electrode, even though some leak current increase was observed before 80 cycles.

These results demonstrated that the decomposition of the nonaqueous electrolytic solution and the nickel dissolution can be suppressed, and that the charge-discharge cycle characteristics can be stably maintained when the negative electrode has a greater capacitance than the positive electrode.

Specifically, a leak current increase was not observed even after 120 cycles in Test Examples 1, 5, and 6. It was therefore confirmed that the decomposition of the nonaqueous electrolytic solution and the nickel dissolution become less likely to occur as the capacitance of the negative electrode exceeds the capacitance of the positive electrode by a factor of at most 2.

### Second Evaluation Test

An evaluation test was conducted while the capacitance balance of the positive and negative electrodes was appropriately varied by varying the material and the surface treatment of the activated carbon. The results are presented in Table 2. Activated carbon from coconut husk was used as the positive electrode activated carbon after a steam-activated surface treatment. On the other hand, a petroleum coke was used as the negative electrode activated carbon after an alkali-treated surface treatment.

In Table 2, Test Examples 9 to 11 represent examples of the present invention in which the negative electrode had a greater capacitance than the positive electrode. Test Examples 12 and 13 represent comparative examples in which the positive electrode had a greater capacitance than the negative electrode.

TABLE 2
Increase in leak current (100% or more)

| | | | | | | | Cycle test under maintained | | |
|---|---|---|---|---|---|---|---|---|---|
| | | | | | Negative/positive | Specific surface | constant voltage (70° C.) | | |
| | | | Activation | Capacitance | capacitance | area ratio | 40 | 80 | 120 |
| | Electrode | Activated carbon | method | (F/electrode) | balance (−) | (negative/positive) | cycles | cycles | cycles |
| Test Ex. 9 | Positive | Activated carbon | Steam | 0.0038 | 167 | 2.19 | Absent | Absent | Absent |
| | electrode | from coconut husk | activation | | | | | | |
| | Negative | Petroleum coke | Alkali | 0.0063 | | | | | |
| | electrode | | activation | | | | | | |
| Test Ex. | Positive | Activated carbon | Steam | 0.0041 | 154 | 2.01 | Absent | Absent | Absent |
| 10 | electrode | from coconut husk | activation | | | | | | |
| | Negative | Petroleum coke | Alkali | 0.0063 | | | | | |
| | electrode | | activation | | | | | | |
| Test Ex. | Positive | Activated carbon | Steam | 0.0062 | 102 | 1.33 | Absent | Absent | Absent |
| 11 | electrode | from coconut husk | activation | | | | | | |
| | Negative | Petroleum coke | Alkali | 0.0063 | | | | | |
| | electrode | | activation | | | | | | |
| Test Ex. | Positive | Activated carbon | Steam | 0.0076 | 83 | 1.08 | Present | Present | Present |
| 12 | electrode | from coconut husk | activation | | | | | | |
| | Negative | Petroleum coke | Alkali | 0.0063 | | | | | |
| | electrode | | activation | | | | | | |
| Test Ex. | Positive | Activated carbon | Steam | 0.0087 | 72 | 0.94 | Present | Present | Present |
| 13 | electrode | from coconut husk | activation | | | | | | |
| | Negative | Petroleum coke | Alkali | 0.0063 | | | | | |
| | electrode | | activation | | | | | | |

As is clear from Table 2, a leak current increase (abnormal charging) due to the decomposition of the nonaqueous electrolytic solution and nickel dissolution occurred before 40 cycles when the positive electrode had a greater capacitance than the negative electrode. In contrast, a leak current increase was not observed even after 120 cycles when the negative electrode had a greater capacitance than the positive electrode.

These results demonstrated that the decomposition of the nonaqueous electrolytic solution and the nickel dissolution can be suppressed, and that the charge-discharge cycle characteristics can be stably maintained when the negative electrode has a greater capacitance than the positive electrode as with the results presented in Table 1.

### Third Evaluation Test

An evaluation test was conducted by using a nonaqueous electrolytic solution that used a cyclic sulfone (sulfolane) as the solvent. The results are presented in Table 3.

In Table 3, Test Examples 13 and 14 represent examples of the present invention in which the negative electrode had a greater capacitance than the positive electrode. In the course of the test, tetrahydrothiophene and thiophene were produced along with the decomposition of the cyclic sulfone (sulfolane) during the charging process. The maximum amounts of the products are presented in Table 3.

TABLE 3
Increase in leak current (100% or more)

| | | | | | | Negative/ | Specific surface | Cycle test under maintained | | |
|---|---|---|---|---|---|---|---|---|---|---|
| | | | | | | positive | area ratio | constant voltage (70° C.) | | |
| | | Activated | Activation | Tetrahydro- | | capacitance | (negative/ | 40 | 80 | 120 |
| | Electrode | carbon | method | thiophen | Thiophene | balance (−) | positive) | cycles | cycles | cycles |
| Test Ex. | Positive | Activated | Steam | 10.0 ppm | 2.9 ppm | 145 | 1.44 | Absent | Absent | Absent |
| 14 | electrode | carbon from | activation | | | | | | | |
| | Negative | coconut husk | | | | | | | | |
| | electrode | | | | | | | | | |
| Test Ex. | Positive | | | 11.4 ppm | 2.8 ppm | 121 | 1.21 | Absent | Present | Present |
| 15 | electrode | | | | | | | | | |
| | Negative | | | | | | | | | |
| | electrode | | | | | | | | | |

As is clear from Table 3, a leak current increase was not observed even after 120 cycles when the amount of the tetrahydrothiophene produced was 10 ppm or less. In contrast, a leak current increase (abnormal charging) was observed before 80 cycles when the tetrahydrothiophene amount exceeded 10 ppm and reached 11.4 ppm.

It was confirmed from these results that the capacitance balance of the positive and negative electrodes should preferably be adjusted to make the tetrahydrothiophene amount 10 ppm or less, even when the negative electrode has a greater capacitance than the positive electrode.

What is claimed is:

1. An electrochemical cell comprising:
a sealing container that includes a base member and a lid member welded to the base member via a weld layer, the base member and the lid member sealing and defining a storage space in between: and
a chargeable and dischargable electrochemical element housed in the storage space and that includes a positive electrode, a negative electrode, and a separation member impregnated with a nonaqueous electrolytic solution,
wherein the positive electrode is electrically connected to the base member,
wherein the negative electrode is electrically connected to the lid member by being overlaid en the positive electrode is the separation member, and allows cations and/or anions to move between the positive electrode and the negative electrode through the nonaqueous electrolytic solution,
wherein the lid member is formed of a metallic material that contains nickel, and
wherein the negative electrode has a greater capacitance than the positive electrode.

2. The electrochemical cell according to claim 1, wherein the capacitance of the negative electrode is greater than the capacitance of the positive electrode by a factor of from 1.13 to 2.

3. The electrochemical cell according to claim 1, wherein the negative electrode has a larger specific surface area than the positive electrode.

4. The electrochemical cell according to claim 2, wherein the negative electrode has a larger specific surface area than the positive electrode.

5. The electrochemical cell according to claim 3,
wherein the positive electrode includes activated carbon subjected to a steam-activated surface treatment, and
wherein the negative electrode includes activated carbon subjected to an alkali-activated surface treatment.

6. The electrochemical cell according to claim 4.
wherein the positive electrode includes activated carbon subjected to a steam-activated surface treatment, and
wherein the negative electrode includes activated carbon subjected to an alkali-activated surface treatment.

7. The electrochemical cell according to claim 3,
wherein the negative electrode and the positive electrode include activated carbon of the same material subjected to the same surface treatment, and
wherein the negative electrode has a smaller density than the positive electrode.

8. The electrochemical cell according to claim 4,
wherein the negative electrode and the positive electrode include activated carbon of the same material subjected to the same surface treatment, and
wherein the negative electrode has a smaller density than the positive electrode.

9. The electrochemical cell according to claim 1, wherein the nonaqueous electrolytic solution contains sulfone as a solvent.

10. The electrochemical cell according to claim 9,
wherein the sulfone is a cyclic sulfone, and
wherein the capacitance of the negative electrode is set to be greater than the capacitance of the positive electrode so that decomposition of the cyclic sulfone upon charging generates tetrahydrothiophene in 10 ppm or less.

11. The electrochemical cell according, to claim 2, wherein the nonaqueous electrolytic solution contains sulfone as a solvent.

12. The electrochemical cell according to claim 11,
wherein the sulfone is a cyclic sulfone, and
wherein the capacitance of the negative electrode is set to he greater than the capacitance of the positive electrode so that decomposition of the cyclic sulfone upon charging generates tetrahydrothiophene in 10 ppm or less.

13. The electrochemical cell according to claim 3, wherein the nonaqueous electrolytic solution contains sulfone as a solvent.

14. The electrochemical cell according to claim 13,
wherein the sulfone is a cyclic sulfone, and
wherein the capacitance of the negative electrode is set to be greater than the capacitance of the positive electrode so that decomposition of the cyclic sulfone upon charging generates tetrahydrothiophene in 10 ppm or less.

15. The electrochemical cell according to claim 4, wherein the nonaqueous electrolytic solution contains sulfone as a solvent.

16. The electrochemical cell according to claim 15,
wherein the sulfone is a cyclic sulfone, and
wherein the capacitance of the negative electrode is set to be greater than the capacitance of the positive electrode so that decomposition of the cyclic sulfone upon charging generates tetrahydrothiophene in 10 ppm or less.

17. The electrochemical cell according to claim 5, wherein the nonaqueous electrolytic solution contains sulfone as a solvent.

18. The electrochemical cell according to claim 17,
wherein the sulfone is a cyclic sulfone, and
wherein the capacitance of the negative electrode is set to be greater than the capacitance of the positive electrode so that decomposition of the cyclic sulfone upon charging generates tetrahydrothiophene in 10 ppm or less.

19. The electrochemical cell according to claim 6, wherein the nonaqueous electrolytic solution contain sulfone as a solvent.

20. The electrochemical cell according to claim 19,
wherein the sulfone is a cyclic sulfone, and
wherein the capacitance of the negative electrode is set to be greater than the capacitance of the positive electrode so that decomposition of the cyclic sulfone upon charging generates tetrahydrothiophene in 10 ppm or less.
